(19) United States
(12) Patent Application Publication
(10) Pub. No.: US 2009/0249207 A1
(43) Pub. Date: Oct. 1, 2009

(54) Method of operating a media player

(76) Inventor: Klaus Lauritsen, Holstebro (DK)

Correspondence Address: HARNESS, DICKEY & PIERCE, P.L.C., P.O. BOX 8910, RESTON, VA, 20195, US

(21) Appl. No.: 12/309,176

(22) PCT Filed: Apr. 30, 2007
(86) PCT No.: PCT/DK2007/000208

§ 371 Date: Jan. 9, 2009

(51) Int. Cl. G06F 3/048; G06F 17/30; G06F 3/00; G11B 27/34; G11B 27/10; G06F 3/01

(52) U.S. Cl. 715/716; 715/835; 715/702

(57) ABSTRACT

A media player and a method of operating the media player in which the events stored therein or available thereto are divided/filtered into groups, each group comprising less than all of the events, and where, when a group of events is provided on the display of the media player, the user may select to have the events of that group provided in a shuffled manner.

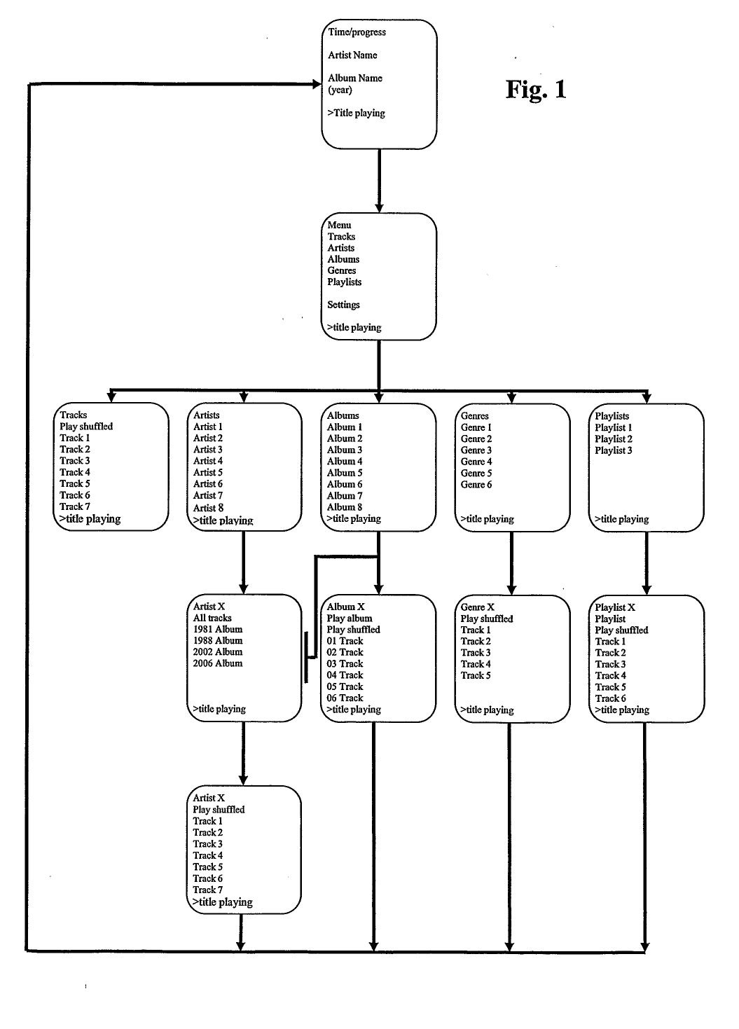

The present invention relates to a method of operating a media player and in particular a method of instructing the media player to shuffle events. The events normally are audio, images or video, such as music tracks, pictures or movies. The media player may be a dedicated media player, such as a standard MP3 player, or may form part of another type of equipment, such as a cellphone or a PDA.

Normally, selecting the function that the media player should shuffle the tracks stored thereon (or at least available thereto) is set in one part of the menu structure away from the positions of selecting the actual tracks. Also, normally, the shuffle function is only available for all tracks of the player.

In a first aspect, the invention relates to a method of operating a media player, the method comprising:
providing a plurality of events adapted to be provided to a user by the media player,
filtering the events in order to identify a group of events comprising less than all of the plurality of events,
providing a user interface allowing the user to view and/or select the group of events,
providing, on the user interface, information to the user relating to the events of one group of events as well as providing the user with the option to have the media player provide the events of the provided group in a shuffled manner.

In the present context, the media player may be a stand-alone media player, such as a standard MP3-player, or it may form part of equipment also having other functions, such as a cellphone, a PDA, a PC or the like.

The events adapted to be provided to the user may be audio, video, any mix thereof, and may be stored in or on the player or be available thereto via e.g. a network or via external storage units.

A group of events may comprise one or more events. Normally events of a group will have one or more parameters in common, such as an author/artist/genre, or the like. These parameters may be provided externally to the media player, or the user may him/herself provide parameters to the events or identify events to belong to a given group. Naturally, an event may be a member of any number of groups. Also, any number of parameters may be used for filtering (author and genre, etc.).

The user interface may be any type of user interface. Normally, the user interface comprises both a display/monitor/sound emitter for providing information to the user as well as means for the user to input information or selections. These input means may be tactile, via buttons, a touch screen, a joystick, a rotatable wheel, touch wheel or the like, or be adapted to receive and interpret audio commands. Alternatively or in addition, the user may input information by moving the player in relation to him/herself or the surroundings, when movement detection means are provided.

Normally, the providing on the user interface of information relating to a group of events will be a list of Identifiers (such as titles of music tracks) which the user may choose from. However, any other manner of providing the information, such as playing a bit of each track or displaying a bit of a video sequence, providing thumbnails of pictures, illustrating bitmaps identifying the track/event or the like may also be used.

While providing the information relating to the events of the group to the user, the user may then choose to have the events of the group provided in a shuffled manner.

At the same time, the user interface or media player may also enable the user to select a single one of the events of the group to be provided or to simply play the tracks in the order given on the display.

In a second aspect, the invention relates to a method of operating a media player, the method comprising:
providing a plurality of events adapted to be provided to a user by the media player,
grouping the events into a plurality of groups, each group of events comprising less than all of the plurality of events,
providing a user interface allowing the user to view and/or select one or more groups of events,
providing, on the user interface, information to the user relating to the events of one group of events,
subsequently, upon a predetermined input from the user, providing the events of the provided group in a shuffled manner.

Consequently, it is clear that upon providing the predetermined input, the media player will require no other actions by the user before starting to provide the events in the shuffled manner. This predetermined input may be the activation of a predetermined button or other touch sensitive element or part of the media player, or any other specific instruction which the media player may interpret.

It should be noted that the present grouping need not be an active grouping of the events but may be Inferred by common parameters assigned to different events, such as common author/artist/label/composer/year of issue, etc.

Naturally, all the above requirements and desires are equally valid for the second aspect.

In a preferred embodiment, the step of providing the events of the provided group in a shuffled manner comprises providing, on the user interface, information relating to a first order of the events of the group, wherein the providing of the events comprises providing the events in an order different from the first order of the events. This is a normal way of defining shuffle: an order different from that in which the events are provided or in which the events Initially were intended (such as the original order of tracks on an album or the chronological order of a movie or pictures).

Alternatively, the events may be provided in the order given on the user interface, or only a single event may be provided, as is usually performed on prior art media players.

In another embodiment, the step of providing the information relating to the events comprises providing, for each event, a text identifying the event. As mentioned above, a number of other manners of identifying each event may be used. Then, a text space or touch sensitive space may also be provided for the user to activate in order to gain the providing or output of the events in a shuffled manner.

In a third aspect, the invention relates to a media player comprising:
a user interface for informing the user of events which may be provided as well as allowing the user to select events to be provided,
means for holding Information relating to a plurality of events,
means for selecting a group of events comprising less than all of the plurality of events by filtering the plurality of events with one or more parameters,
means for providing information to the user in relation to the events of the group,
means for, simultaneously to the providing, allowing the user to select the providing of the events of the group in a shuffled order,
means for providing the events of the group in a shuffled order.

In a fourth aspect, the invention relates to a media player comprising:
a user interface for informing the user of events which may be provided as well as allowing the user to select events to be provided,
means for holding information relating to a plurality of events, the events being divided into one or more groups each comprising less than all of the plurality of events,
means for providing information to the user in relation to the events of one of the groups,
means for, simultaneously to the providing, allowing the user to select the providing of the events of the group in a shuffled order,
means for providing the events of the group in a shuffled order.

As mentioned in relation to the first two aspects, the user interface may be of any desired kind but normally will comprise a display/monitor and means for the user to input instructions to the media player in order to select events to be provided and/or navigate in a menu structure of the media player. In particular cases, the media player may be adapted to output audio information relating to e.g. events which may be provided as well as receive information either as sound or as movement of the media player or part thereof.

The holding means may actually store all the events and/or may store or hold information relating to events which are available from other sources. Any type of storage (RAM, ROM, PROM, EPROM, EEPROM, Flash, tape, disc, card, electrical, magnetic, or optical, or the like) may be used.

The events may be divided into the groups on beforehand, or a filtering process may be available for filtering the events in any desired manner. Normally, parameters such as Author, Date, type of event (mpg, mp3, mp4, tiff, etc.) are stored with the event, so that the filtering may be performed when desired.

The means for allowing the user to select between the events of the group may form part of the user interface ad may, as described above, be of any desired type, such as touch buttons, touch pads, touch wheels, rotatable wheels, or the like.

Naturally, when providing the information relating to the events of the group, the user interface may not be adapted to actually represent all events of the group simultaneously. This may be as the situation in which a title of each track of an album are represented on a small display, where scrolling is required in order to see all titles. Nevertheless, the Information relating to all tracks/events are provided in the same view.

At the same time, the user may input an instruction to have the media player provide the events of the displayed group in a shuffled manner.

Preferably, the means allowing the user to select is adapted to provide the events in a first order, and wherein the means for providing the events in a shuffled order are adapted to provide the events In an order different from the first order. Thus, the shuffled order is an order different from an order in which the events are provided.

In the following, a preferred embodiment of the invention will be described with reference to the drawing, illustrating a manner of navigating in a menu in a media player according to the invention.

At the top of the drawing, a user interface is Illustrated as seen when playing music to a user using a standard MP3-player. The Artist Name, Album Name and title may be provided. When stopping the music (one step down in the drawing), the user interface will return to a starting view at which the user is able to select between all tracks stored on the media player (the left-most column). Selecting simply “tracks”, the user will be presented with a full list of the plurality of tracks stored on the media player (or to which the media player has access).

The user may instead wish to select or search between only a part of the events/music pieces on the player. This is facilitated in a number of manners: the user can select between a grouping/filtering as to “Artist”. “Album”, “Genre” or “Playlist”. Each of these groups normally represents only a part of the tracks stored on the media player.

Selecting “Artist” results (second column from the left) in the user interface presenting the user with a list of the artists having authored tracks stored on the media player. The user thereafter will select an Artist, whereby only the group of events made by that artist is provided, whereby the user interface will inform the user of the tracks authored by the selected Artist.

Selecting “Album” (third column from the left) will result in the user interface presenting the user with a list of the tracks, stored on the media player, and being from the selected album. Normally, these tracks will have a predetermined order determined by the order of the tracks on the actual album.

Selecting “Genre” (fourth column from the left) will result in the user interface presenting the user with a list of different genres, such as pop, rock, folk. Having selected a Genre, the user interface will present the user with a number of tracks, stored on the media player, which fall under the selected Genre.

Finally, selecting “Playlist” (right column) results in the user interface presenting to the user a list of Playlists. Selecting a Playlist will result in the user interface providing to the user the tracks of the playlist. Also in this situation, the tracks may be presented in a predetermined order.

In any case, when the tracks presented (all columns but the left column) are from a filtered group not being the full list of tracks stored on the media player, the user interface simultaneously and additionally makes the user able to select not only the providing (playing) of the events of the group (Album, Artist, Genre, Playlist . . . ) but also to provide these tracks in a shuffled manner. Thus, the manner of actually providing the tracks will differ from that in which the tracks were presented on the user interface.

Naturally, the user may also be able to instruct the player to provide the events in the order provided (not shuffled)—such as the order in which events are provided on an album.

It is noted that when presenting the user with this choice at this point in the navigation in the menu structure of the media player, the last selection which the user makes actually is the “play shuffle” selection. At this point, the tracks to be shuffled already are selected.

In addition to this navigation method, the user may also be able to choose that one or more tracks are repeatedly provided. Thus, when the tracks to be provided are selected either by selecting the actual track, the Album, all tracks of which are to be provided, the Artist, all available tracks of which are to be provided, or a Playlist, all tracks of which are to be provided, the media player may either play all tracks a single time (repeat off) or repeat the track/tracks indefinitely (repeat on).

If, however, the user has decided to shuffle a filtered group of tracks (selected by Artist, Album, Genre or Playlist, e.g.), the media player may be adapted to always play the shuffled tracks indefinitely, i.e. independently of whether the user has selected the “repeat” function of the media player.

1-7. (canceled)

8. A method of operating a media player, the method comprising:
providing a plurality of events adapted to be provided to a user by the media player,
filtering the events in order to identify a group of events comprising less than all of the plurality of events,
providing a user interface allowing the user to view and/or select the group of events,
providing, as a list comprising identifiers on the user interface, information to the user relating to the events of one group of events, the list further comprising an activatable text space or touch sensitive space providing the user with the option to have the media player provide the events of the provided group in a shuffled manner.

9. A method of operating a media player, the method comprising:
providing a plurality of events adapted to be provided to a user by the media player,
grouping the events into a plurality of groups, each group of events comprising less than all of the plurality of events,
providing a user interface allowing the user to view and/or select one or more groups of events,
providing, as a list comprising identifiers on the user interface, information to the user relating to the events of one group of events, the list further comprising an activatable text space or touch sensitive space,
subsequently, upon the user selecting the activatable text space or touch sensitive space on the list, providing the events of the provided group in a shuffled manner.

10. A method according to claim 8, wherein the step of providing the events of the provided group in a shuffled manner comprises providing, on the user interface, information relating to a first order of the events of the group, wherein the providing of the events comprises providing the events in an order different from the first order of the events.

11. A method according to claim 9, wherein the step of providing the events of the provided group in a shuffled manner comprises providing, on the user interface, information relating to a first order of the events of the group, wherein the providing of the events comprises providing the events in an order different from the first order of the events.

12. A method according to claim 8, wherein the step of providing the information relating to the events comprises providing, for each event, a text identifying the event.

13. A method according to claim 9, wherein the step of providing the information relating to the events comprises providing, for each event, a text identifying the event.

14. A media player comprising:
a user interface for informing the user of events which may be provided as well as allowing the user to select events to be provided,
means for holding information relating to a plurality of events,
means for selecting a group of events comprising less than all of the plurality of events by filtering the plurality of events with one or more parameters,
means for providing, as a list comprising identifiers, on the user interface, information to the user in relation to the events of the group, the list further comprising an activatable text space or touch sensitive space,
means for, simultaneously to the providing, allowing the user to select the activatable text space or touch sensitive space on the list so as to provide the events of the group in a shuffled order,
means for providing the events of the group in a shuffled order.

15. A media player comprising:
a user interface for informing the user of events which may be provided as well as allowing the user to select events to be provided,
means for holding information relating to a plurality of events, the events being divided into one or more groups each comprising less than all of the plurality of events,
means for providing, as a list comprising identifiers, on the user interface, information to the user in relation to the events of the group, the list further comprising an activatable text space or touch sensitive space,
means for allowing the user to select between the events of one of the groups,
means for, simultaneously to the allowing, allowing the user to select the activatable text space or touch sensitive space on the list so as to provide the events of the group in a shuffled order,
means for providing the events of the group in a shuffled order.

16. A media player according to claim 14, wherein the means allowing the user to select is adapted to provide the events in a first order, and wherein the means for providing the events in a shuffled order are adapted to provide the events in an order different from the first order.

17. A media player according to claim 15, wherein the means allowing the user to select is adapted to provide the events in a first order, and wherein the means for providing the events in a shuffled order are adapted to provide the events in an order different from the first order.
